(19) United States
(12) Patent Application Publication
(10) Pub. No.: US 2016/0123192 A1
(43) Pub. Date: May 5, 2016

(54) PROCESS AND PLANT FOR POWER GENERATION

(71) Applicant: Parsons Brinckerhoff Limited, Newcastle Upon Tyne (GB)

(72) Inventor: Paul Michael Willson, Manchester (GB)

(21) Appl. No.: 14/927,293

(22) Filed: Oct. 29, 2015

(30) Foreign Application Priority Data
Oct. 30, 2014 (GB) 1419342.9

(51) Int. Cl. F01K 23/10; F02C 6/18

(52) U.S. Cl. CPC F01K 23/101; F02C 6/18

(57) ABSTRACT

Power generation plant and process comprising: providing a steam generator; first, second and third steam turbines; a reheater; a gas turbine; and at least one heat exchanger; supplying feedwater bypassing the steam generator to the heat exchanger and heating the feedwater stream therein by supplying the at least one hot exhaust gas stream from the gas turbine to the heat exchanger; and recovering heated steam from the heat exchanger and supplying at least part of the recovered heated steam stream to the second steam turbine to generate power in the second steam turbine.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57.

### BACKGROUND OF THE INVENTION

Steam turbine power generation plants are one of the oldest power generators and supply most of the world's power.

One conventional steam turbine power generation plant operates according to a process in which high pressure saturated steam from a steam generator is fed, directly or indirectly, to a high pressure wet steam turbine and is expanded and cooled therein with the associated generation of power by the turbine. Cooled and expanded steam from the turbine may be supplied to a moisture separator/reheater and then via a low pressure steam turbine to a condenser. Condensed steam from the turbine may be supplied to a de-aerator and returned, generally through a feed pump and feed heaters, to the steam generator. A plant based on such a conventional wet steam cycle is described in ‘Advances in Power Station Construction’, GD&CD, Central Electricity Generating Board published by Pergammon Press 1986.

Conventionally, the cooled and expanded steam supplied to the moisture separator/reheater is generally separated into two streams. A first stream comprising separated moisture may be supplied to the de-aerator in combination with condensed steam from the turbine. A second stream is reheated and supplied to a low pressure steam turbine for further power generation. Reheating of this stream in the moisture separator/reheater is effected by steam from the steam generator and/or extracted from the high pressure wet steam turbine.

Steam from the low pressure steam turbine is exhausted to a condenser, from which water is pumped through one or more low pressure feed heaters before being supplied to the de-aerator and thence back to the steam generator. The low pressure feed heaters may be supplied with heating steam extracted from the low pressure turbine.

Many attempts have been made to improve the efficiency of conventional steam raising plant, in particular nuclear plant, by combining into the steam cycle the exhaust power output from a gas turbine. Examples of such attempts are disclosed in Japanese Laid-open patent publication nos. 2003027906, 11344596, 10089016, 10037717 and 3151505, and in U.S. Pat. No. 5,457,721.

One hybrid power generation plant disclosed in UK Patent GB 2431968A operates according to a process in which part of the steam from a conventional steam generator is superheated using the heat in the exhaust gases of a gas turbine. The superheated steam is passed directly or indirectly to be expanded in a steam turbine, thereby generating power.

In this hybrid power generation plant, part of the feedwater to the steam generator is also supplied to an evaporator also heated by the gas turbine exhaust gases. The steam produced in the evaporator is mixed with the steam from the steam generator. Conventionally the exhaust gases of the gas turbine are directed to first heat the steam from the steam generator and then to evaporate additional feedwater in the second heat exchanger.

Improvements to this power generation plant have been sought to enable the process to maximize steam flow to the steam turbine when little or no steam is available from the steam generator. Such an improvement would allow the power plant to deliver its full capacity when the steam generator was being maintained or when maximum production of power was needed to respond to the demands on the electricity network.

There is a current and growing need for efficient power generation in many areas of the world to meet energy demands while reducing carbon emissions. The production of low carbon power by many renewable technologies varies over a wide range of timescales according to weather, season or time of day. Power generation from other sources needs to balance this variation while meeting the daily, weekly and seasonal patterns of demand from consumers. There is thus an increasing need for efficient power generation technologies that can deliver different levels of output flexibly when required to balance power demands while minimizing carbon emissions.

Further, there remains a need to provide an improved process and apparatus for power generation which improves energy efficiency and therefore lowers cost and damage to the environment in relation to conventional power plants. In particular, the use of a combined cycle power plant in conjunction with a nuclear power plant using either the pressurized or boiling water cycles offers opportunities for efficiency improvement.

However, it has proved difficult in practice to realize such improvements, for example because of the restrictions imposed by nuclear safety requirements and the limitations of electrical transmission network operation. Nuclear safety requirements generally mean that external disturbances to steam flows in the steam generators should be minimized or avoided. The electrical transmission network limitations mean that single breakdowns should not result in losses of generation above a defined maximum value. These restrictions limit acceptable configurations of the combined gas turbine and nuclear steam cycles. In one of its aspects, the present invention comprises a plant configuration that offers the desired high levels of efficiency within these limitations.

### SUMMARY OF THE INVENTION

According to one embodiment of the present invention, there is provided a process for power generation comprising: providing a steam generator, first, second and third steam turbines, a reheater, a gas turbine, at least one heat exchanger and a combustion means for burning fuel in hot gas, the process having plural modes of operation.

In various embodiments, the present invention provides process and plant for power generation comprising: providing a steam generator; first, second and third steam turbines; a reheater; a gas turbine; and at least one heat exchanger; supplying a first stream comprising steam from the steam generator to the first steam turbine to generate power in the first steam turbine; recovering from the first steam turbine a recovered stream comprising steam and supplying at least a part of the recovered stream to the reheater; supplying a second stream comprising steam from the steam generator to a first zone of the heat exchanger and heating the second stream therein by supplying at least one hot exhaust gas from the gas turbine to the first zone of the heat exchanger; supplying the heated second stream to the second steam turbine to generate power therein; supplying a third stream comprising steam from the steam generator to the reheater to heat the recovered stream from the first steam turbine; recovering from the reheater a heated recovered stream from the first turbine; and supplying at least part of the heated recovered stream from the first turbine to the third steam turbine to generate power therein, wherein an exhaust gas can be obtained from the heat exchanger and an additional source of fuel combusted with the exhaust gas before it is supplied back to the heat exchanger.

In an embodiment, the first mode of operation is one comprising: supplying a first stream of feedwater to the steam generator and generating a steam output therefrom; supplying a first stream comprising steam from the steam generator to the first steam turbine to generate power in the first steam turbine; recovering from the first steam turbine a recovered stream comprising steam and supplying at least a part of the recovered stream to the reheater; supplying a second stream comprising steam from the steam generator to the heat exchanger and heating the second stream therein by supplying at least one hot exhaust gas from the gas turbine to the heat exchanger; supplying the heated second stream to the second steam turbine to generate power therein; supplying a third stream comprising steam from the steam generator to the reheater to heat the recovered stream from the first steam turbine; recovering from the reheater a heated recovered stream from the first turbine; and supplying at least part of the heated recovered stream from the first turbine to the third steam turbine to generate power therein.

In an embodiment, the second mode of operation is one comprising: supplying a first stream of feedwater to the steam generator and generating a stream of steam therefrom; supplying a first stream comprising steam from the steam generator to the first steam turbine to generate power in the first steam turbine; recovering from the first steam turbine a recovered stream comprising steam and supplying at least part of the recovered stream to the reheater; supplying a second stream comprising steam from the steam generator to the reheater to heat the recovered steam from the first steam turbine; recovering from the reheater a heated recovered stream from the first steam turbine; and supplying at least part of the heated recovered stream from the first steam turbine to the third steam turbine to generate power in the third steam turbine.

In an embodiment, the third mode of operation is one comprising: supplying feedwater bypassing the steam generator to the heat exchanger and heating the feedwater stream therein by supplying at least one hot exhaust gas from the gas turbine to the heat exchanger; and recovering heated steam from the heat exchanger and supplying at least part of the recovered heated steam stream to the second steam turbine to generate power in the second steam turbine;

In an embodiment, the fourth mode of operation is comprising: at least one of two additional modes of operation corresponding to the first and third modes of operation respectively and comprising the additional steps of recovering an exhaust gas stream from the heat exchanger and combusting an additional fuel to reheat the exhaust gas stream before it is supplied back to the heat exchanger.

At least one embodiment, the present invention therefore provides a more efficient process for generating power, which makes use of any energy that would otherwise be lost in the exhaust gas from the heat exchanger. The heat exchangers used in one embodiment of the present invention are not 100% efficient and so there will be some heat remaining in the exhaust gas. Conventionally, this would be lost as the exhaust gas would be released after it has passed through the heat exchanger, as the temperature of the gas would be too low for it to be used to generate steam.

However, in at least one embodiment, the present invention utilizes an additional fuel source to raise the temperature of the waste gas, thereby allowing it to be supplied back to the heat exchanger to generate steam, which can then be used to power the steam turbines. The combustion of the additional fuel allows a much higher proportion of the energy in the exhaust gas to be used than is possible in hybrid systems of the prior art. This therefore means that the generation capacity when the steam generator is not available is much increased compared to hybrid plants of the prior art.

In one embodiment, a preferred process in accordance with the invention the heat exchanger has plural zones, including at least a first zone and a second zone. The plural zones of the heat exchanger may be separate and may comprise separate heat exchangers.

In this situation, the separate heat exchanger zones may have different roles within the arrangement of at least one embodiment of the present invention. This allows the heat exchanger zones to operate under different conditions and with different sources of energy. It also means that the heat exchanger zones can communicate with each other in a manner that would not be possible if they were interconnected.

For example, at least one exhaust gas stream may be recovered from the first zone of the heat exchanger and then supplied to the second zone of the heat exchanger. This means that the exhaust stream from the first zone may be used to at least partially supply the energy required to generate steam in the second zone. This therefore reduces the amount of energy that is wasted within the system and thereby improves efficiency.

If the energy in the exhaust stream of the first zone is not sufficient to supply the energy required to generate steam in the second zone, the additional fuel may be combusted to reheat the exhaust gas before it is supplied to the second zone of the heat exchanger. This will then increase the temperature of the exhaust stream to a level sufficient to generate steam in the second zone.

The first mode of operation may comprise supplying the second stream comprising steam from the steam generator to a first zone of a heat exchanger, wherein the second stream is heated therein by supplying at least one hot exhaust gas from the gas turbine to the first zone of the heat exchanger.

In an embodiment, the first mode of the present invention may further comprise the steps of: supplying a second stream of feedwater to the second zone of the heat exchanger; generating a stream comprising steam; and mixing the steam from the second zone of the heat exchanger with the second stream of steam from the steam generator.

This therefore allows separate functioning of the first and the second zones of the heat exchanger, so that the two can perform different roles in the arrangement of at least one embodiment of the present invention. Specifically, the first zone of the heat exchanger heats the steam required to power the second steam turbine while the second zone creates steam to supplement that provided by the steam generator.

The features of the steam required for these different functions may also differ and so the two heat exchanger zones should be able to function under different conditions. Additionally, this allows the exhaust gas from the first zone to be used in the second zone, with or without the additional fuel being combusted, as different levels of energy may be required.

The stream comprising steam created in the second zone of the heat exchanger in the first mode of operation may further comprise water. This stream may therefore be supplied to a separator before the steam in the stream is mixed with the second stream of steam from the steam generator and the water produced in the separator may be recirculated to the second zone or be supplied to the steam generator as at least part of the feedwater supplied thereto. This further improves the efficiency of the arrangement of at least one embodiment of the present invention.

In the third mode of operation of the plant, the feedwater bypassing the steam generator may be supplied to the second zone of the heat exchanger in which it is heated and at least partially evaporated before the steam stream therefrom is supplied to the first zone of the heat exchanger. This enables the system to generate power in the second steam turbine independently of the operation of the steam generator.

The first zone of the heat exchanger in the third mode of operation may be heated using at least one hot exhaust gas from the gas turbine. This is a convenient source of energy for the generation of steam. This hot exhaust gas may then be passed to the second heat exchanger, which may operate at a lower temperature than the first. However, if the temperature is too low to create steam, the additional fuel may be combusted. This therefore improves efficiency while allowing the temperatures in the heat exchanger zones to be controlled.

The third mode of operation may comprise: supplying the at least partially evaporated heated feedwater stream from the second zone of the heat exchanger to a separator; and recovering from the separator a steam stream and supplying said steam stream to the first zone of the heat exchanger.

As discussed above, the use of a separator may further improve the efficiency of the process.

Preferably in said first mode of operation of the plant, the second stream from the steam generator is supplied to the first zone of the heat exchanger at a temperature and pressure not substantially below that of the second stream as it is recovered from the steam generator. For example, the pressure of the second stream as it is supplied to the first zone of the heat exchanger is not more than about 15%, preferably not more than about 10%, most preferably not more than about 5% below the pressure of the second stream as it exits the steam generator.

The output streams from the second and third steam turbines are preferably supplied, in whole or in part to one or more condensers. In one preferred process according to an embodiment of the invention, at least part of the output stream from the second steam turbine condenser is supplied to a third zone of the heat exchanger and heated therein by supplying at least one hot exhaust gas from the gas turbine to the third zone of the heat exchanger. The heated recovered condensate may then be returned to a de-aerator heated with steam extracted from between stages of the second turbine. The part of the output stream from the condenser supplied to the third zone of the heat exchanger may also be passed through one or more low pressure feed heaters.

The heat exchanger is preferably arranged so that the at least one hot exhaust gas is passed against at least one first heat transfer surface in the first zone of the heat exchanger to heat second stream from the steam generator, so that the at least one hot exhaust gas is passed against at least one second heat transfer surface in the second zone of the heat exchanger to heat the auxiliary heating stream for the reheater, and so that the at least one hot exhaust gas is passed against at least one third heat transfer surface in the third zone of the heat exchanger to heat the recovered condensate stream from the condenser, or part of it. Preferably, the at least one hot exhaust gas from the gas turbine is passed sequentially against the at least one first heat transfer surface, the at least one second heat transfer surface and the at least one third heat transfer surface, becoming progressively cooler from the first to the third zones of the heat exchanger. The thus cooled at least one hot exhaust gas may then be discharged from the plant by any suitable means, such as by means of a stack.

In one process according to an embodiment of the invention, the first steam turbine is a wet steam turbine and the steam in the first stream from the steam generator is supplied at or at close to a saturated condition. The first steam turbine preferably operates under a high pressure condition, by which is meant by way of example only that the pressure of steam supplied thereto is at least about 40 bar abs. The third steam turbine preferably operates under a relatively low pressure condition, by which is meant by way of example only that the pressure of steam supplied thereto is less than about 10 bar abs. Preferably the second steam turbine is operable at a pressure intermediate between that of the first and third steam turbines, more preferably at a pressure as close as possible to that of the first steam turbine.

The flow ratio of the stream supplied to the second steam turbine to the first steam stream from the steam generator may be between about 0.05 to about 0.5, preferably between about 0.05 to about 0.2.

In one preferred process according to an embodiment of the invention, the total enthalpy of the at least one hot exhaust gas stream supplied from the gas turbine is from about 0.05 to about 0.35, preferably from about 0.05 to about 0.25, most preferably from about 0.07 to about 0.15, of the net enthalpy of materials recovered from the steam generator (that is the enthalpy of the first steam stream supplied from the steam generator minus the enthalpy of feedwater stream).

The ratio of maximum energy added in additional fuel to energy in exhaust gases of gas turbine may be between 50 to 120%, preferably between 60 and 110% and more preferably between 80 and 100%.

Preferably the reheater also functions as a moisture separator. Wet steam exhausted from the first steam turbine is passed to the moisture separator/reheater which removes moisture droplets which are returned directly or indirectly as feedwater for the steam generator. The recovered moisture stream may be supplied to the de-aerator separately or together with the part of the recovered stream from the first steam turbine. As with the first steam turbine recovered stream part, the moisture supplied to the de-aerator may be passed to the steam generator via a feed pump and at least one, optionally high pressure, feed heater.

Preferably the water from the de-aerator is supplied to a feedwater pump which pressurizes it and applies the stream to at least one high pressure feedwater heater. The recovered heated stream from the at least one feedwater heater is supplied to the steam generator. The at least one feedwater heater may be supplied with steam extracted from the first steam turbine to heat the feedwater.

In another preferred first mode of operation the process comprises: providing feedwater to the second zone of the heat exchanger, the feedwater stream being heated in the second zone of the heat exchanger by the at least one hot exhaust gas; recovering a heated feedwater stream from the second zone of the heat exchanger and supplying the recovered heated feedwater stream to a separator; recovering from the separator the heated feedwater stream and supplying the recovered stream to the steam generator as at least part of the feedwater supplied thereto.

Conveniently, in said second mode of operation of the plant, the second stream from the steam generator is supplied directly to the heat exchanger, by which is meant in particular that it is not first supplied as input to any steam turbine or heat exchanger.

Preferably the first steam stream is supplied from the steam generator at a pressure of from about 40 to about 80 bar abs.

Preferably the temperature and pressure of the second steam stream are substantially the same as the first steam stream.

Preferably the temperature and pressure of the third steam stream are substantially the same as the first steam stream also.

Preferably, the first stream comprises the majority of the steam generator output, for example at least about 55% thereof, more preferably at least about 70% thereof.

In another preferred process the heated recovered condensate from the third zone of the heat exchanger may be supplied to a second deaerator. In this alternative process the separate at least one feed pumps pressurize the water from the second deaerator and deliver low temperature feedwater to the second zone of the gas turbine energy recovery heat exchanger.

The heat exchanger may be constructed as a single unit with multiple stages therein, or may be constructed as separate units, preferably arranged in series.

The heat exchange tubes may be of any suitable material, such as the various grades and specifications of steel appropriate to the internal and external conditions and may included extended surfaces such as finning necessary for optimum heat transfer.

The feedwater used to provide steam to the second steam turbine may be isolated from the feedwater used to provide steam to the first and/or third steam turbines. This may include isolating the stream that originates from the steam generator from that which passes through the heat exchanger. In this embodiment, there are therefore two separated pathways in which water and/or steam can flow. However, the two pathways are thermally connected, with heat passing between the two.

In one embodiment, the first mode of operation may not require steam to pass directly from the steam generator to the heat exchanger. Instead, the transfer of steam may be indirect. The first mode of operation may further include passing the second stream comprising steam from the steam generator to a steam heated evaporator in which a flow of feedwater that is isolated from the second stream comprising steam from the steam generator is evaporated by at least partially condensing the second stream comprising steam from the steam generator. This isolated stream may be subsequently passed to the heat exchanger and then onto the second steam turbine.

The first mode of operation may further include passing the condensed water recovered from the second steam turbine through one or more feedheaters in which the condensed water is heated by cooling or at least partially condensing the second stream comprising steam from the steam generator. These feedheaters act to further thermally connect the two pathways and mean that much of the heat from the second stream comprising steam from the steam generator is transferred to the second pathway, which generates power using the second turbine.

There may be a feedheater directly after the condensed water is recovered. In one embodiment, the condensed water stream is split, with one stream going to the heat exchanger and another going to the feedheater. Preferably, if there are multiple heat exchangers, the condensed water is passed to the second heat exchanger. The two condensed water streams may then subsequently be combined.

Additionally or alternatively, a feedheater may be present after the condensed water has been passed through the heat exchanger. If there are multiple heat exchangers, the feedwater may pass from the second heat exchanger, to this feedheater, before being passed back to the first heat exchanger.

According to a second aspect of an embodiment of the present invention, there is provided a power generation plant configured to operate the process described herein.

In various embodiments, the process of the invention when exemplified in a preferred process in accordance with embodiments of the invention has the following significant advantages:

It significantly improves the thermal efficiency of the gas turbine and the saturated steam cycles integrated in the hybrid cycle. The net thermal efficiency of the hybrid cycle may for example be about 39%-42% compared with the base saturated steam cycle at 33%.

When the improvements are attributed to the addition of the gas turbine cycle, the efficiency of gas to additional power compared with the original saturated steam cycle is substantially higher than can be realized by other means, permitting 60-65% net conversion efficiency to be achieved.

The specific capital cost of the additional capacity of the hybrid plant is comparable with that for a combined cycle gas turbine rather than a conventional power plant or nuclear plant.

The specific operating and maintenance costs for the cycle are lower than for a comparable combined cycle gas turbine plant as the net capacity is significantly increased for the same gas turbine maintenance costs.

The higher fuel conversion efficiency and lower specific capital and operations and maintenance costs of the generating capacity enables power to be generated from gas at a significantly lower cost than any available alternative technologies, typically offering output at about 90% of the cost of a conventional combined cycle gas turbine plant with the same cost of fuel.

Configuration of the integrated steam cycle minimizes the impact of disturbances in the gas turbine cycle, such as gas turbine shutdowns, on the saturated steam plant and enables the saturated steam generator to continue to function normally despite such disturbances. The small effects on the steam generator mean that safety issues related to any nuclear primary circulation through the steam generator are minimized.

The peak power available from the gas turbine and second steam turbine by the use of additional fuel to reheat the exhaust gases can be delivered independently of operation of the steam generator.

While outstanding efficiency of the gas turbine cycle is achieved in integrated operation with the steam generator, operation of the gas turbine cycle is maintained at reasonably high efficiency while the steam generator is out of service. Thus the high availability of the gas turbine cycle contributes to revenues while the steam generator is shutdown, e.g. for nuclear plant refueling.

Start-up and shutdown of either the (nuclear) steam generator or the gas turbine can be accomplished flexibly, simply and with minimum mutual interference, maintaining safety provisions for the nuclear steam system while permitting flexible dispatch of the gas turbine cycle capacity.

The additional capacity from the gas turbine cycle can be dispatched flexibly according to power demand without significantly affecting the saturated steam plant.

Breakdown of either the gas turbine plant or the heat supply to the steam generator do not result in a total loss of generated output. The breakdown cases have a predictable loss of output to the electrical transmission network which are the same as the values for the gas turbine, energy recovery heat exchanger and second steam turbine or conventional nuclear plant independently.

The improved efficiency of fuel conversion results in environmental benefits including reductions of around about 10% of emissions per unit of energy delivered of carbon, sulfur and nitrogen oxides and lower thermal discharges to the environment compared with the best available fossil fueled plant. The additional lower cost generating capacity will displace older more expensive plant with higher emissions, further reducing the overall discharges to the environment.

The concept can be applied to new power plant or to existing saturated steam cycle plant with similar benefits.

The design of the heat exchanger zones and the separator are conventional for energy recovery heat exchangers in combined cycle gas turbine power plant so that costs of construction are minimized.

The enhanced robustness of the gas turbine cycle operation on shutdown of the (nuclear) steam generator increases the integrity of power generation available to support safe reactor operation during the critical shutdown period.

Transitions of conditions in the heat exchanger are smooth and self-regulating so that operation is simplified and cycle behavior is tolerant of changes in steam cycle or gas turbine conditions.

The construction of the gas turbine and nuclear plants can be undertaken at different times while permitting operation at up to full capacity but at reduced efficiency prior to completion of the hybrid cycle.

The design of the steam and water cycle associated with the gas turbine can be designed for maximum independence from the nuclear steam cycle so that interfaces for a retrofit can be minimized and any potential safety case impacts reduced to the lowest possible level.

The process can deliver a significantly higher fuel efficiency than a conventional combined cycle using the same gas turbine, offering reduced carbon and other gaseous emissions per unit energy production.

The additional power available to meet demand by the combustion of supplementary fuel is a much larger proportion of gas turbine power than can be achieved by a conventional high efficiency combined cycle plant.

The specific cost of capacity for the improved process is significantly lower than for the disclosed process in UK Patent GB 2431968A and is lower than or similar to the specific costs applicable to conventional combined cycle power plant.

The generation capacity of the plant when the steam generator is not available is much increased compared with that offered by a hybrid plant as disclosed in UK Patent GB 2431968A.

When the steam generator supplies steam at a substantially constant pressure and temperature, the hybrid combined cycle plant can change output upwards or downwards at a rate comparable with gas turbine alone, which is typically an order of magnitude faster than conventional combined cycle power plant is able to offer, in both cases within the permissible rates of change of conditions for the plant components without cyclic life reduction;

The additional flexibility of the improved process increases the range of roles a plant embodying the process can fulfil within a power system, offering advantages for the system operator and improved opportunities for plant owner to raise revenues for providing additional services to the power system;

The additional flexibility of the improved process would enable an electricity system to which a plant embodying the process was connected to include a higher proportion of intermittent renewable generation than would be feasible with a conventional combined cycle power plant, thereby reducing carbon dioxide and other gaseous emissions more significantly that for the power plant alone or if a combined cycle plant was used for this duty.

### BRIEF DESCRIPTION OF THE DRAWINGS

Embodiments of the invention will now be more particularly described with reference to the following drawings, in which:

FIG. 1 shows a flow diagram of a hybrid power generation plant arranged to operate according to an embodiment of a first process of the invention;

FIG. 2 shows a flow diagram of a hybrid power generation plant arranged to operate according to an embodiment of a first process of the invention, which corresponds to the data in Table 1; and

FIG. 3 shows a flow diagram of a hybrid power generation plant arranged to operate according to an embodiment of a second process of the invention.

### DETAILED DESCRIPTION OF THE PREFERRED EMBODIMENT

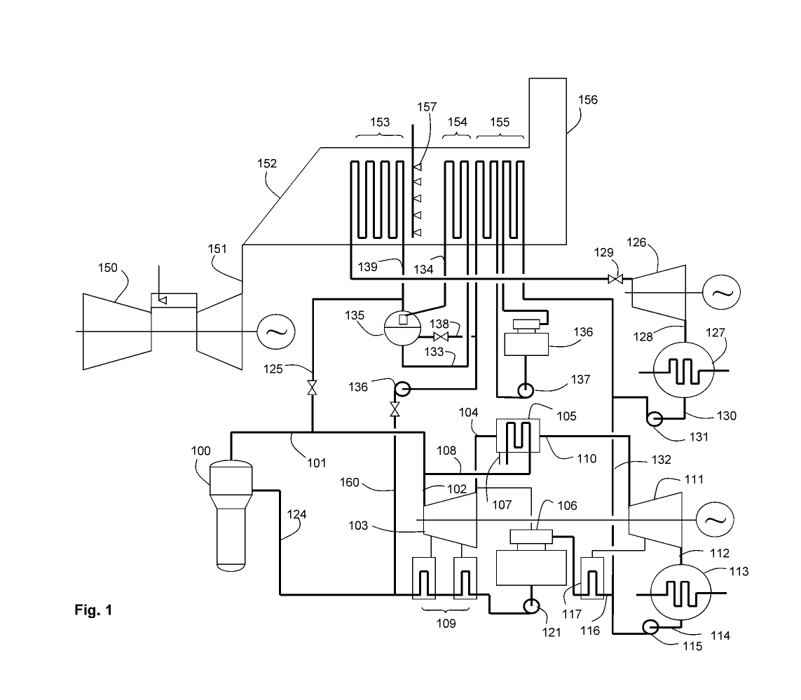

Referring to FIG. 1, gas turbine 150 produces hot exhaust gases which are passed in line 151 through energy recovery heat exchanger 152. The exhaust flows in turn over heat transfer surfaces with their outlet passes at the side facing the incident hot gases to maintain a near constant temperature difference between the external hot gases and the internal process fluid. The first zone of the heat transfer surface, in contact with the hottest gases, is steam superheater 153. On leaving the first zone the exhaust gases may be reheated by combustion of a fuel in the burners 157 before flowing through the second zone of the energy recovery heat exchanger 154.

The intermediate section of the heat exchanger 154 acts as an evaporator through which water is circulated by pumps (not shown) or by natural convection from separator 135 via lines 133 and 134. The final heat exchange surface is economizer section 155 which is in two parts. The first heats water directly from condenser 127 of steam turbine 126, or after passage through one or more feedheaters (not shown), delivering it to deaerator 136.

Dissolved gases are removed by vigorous direct contact heating of water droplets by steam in the deaerator 136. Steam extracted from between stages of steam turbine 126 or other steam source (not shown) is used to heat deaerator 136.

One or more pumps 137 delivers feedwater from deaerator 136 at high pressure to the second part of economizer 155 which heats water to flow in part to separator 135 via line 138 with the balance via one or more pumps 136 (optional, according to design) and line 160 to mix with feedwater in line 124 to the steam generator 100.

The cool exhaust gases from the energy recovery heat exchanger are finally discharged via stack 156.

The steam flows in the cycle are integrated with the conventional steam turbine cycle for steam at close to saturated conditions as follows. Steam at near saturated conditions from steam generator 100 is supplied in line 101 and is divided into three, with a large part flowing in line 102 to wet steam turbine 103, another part passing in line 125 to mix with steam from separator 135 in line 139 to superheater 153 for heating, while the balance flows in line 108 to moisture separator and reheater 105.

The steam heated in superheater 153 in gas turbine heat energy recovery exchanger 152 is delivered at high temperature to secondary steam turbine 126 which exhausts into condenser 127 via line 128. Condensed water is recovered via line 130 and pump 131 with part flowing via line 132 to mix with the condenser flow from the low pressure steam turbine 111 in line 116. The balance of the condensed steam flow from pump 131 is delivered to the cold end of the economizer 155.

Steam flow through steam turbine 126 is set by inlet valve 129 and is preferably controlled to maintain a constant steam temperature at the outlet of superheater 153.

Steam at near saturated conditions flows though the high pressure turbine 103 which exhausts wet steam in line 104 to moisture separator/reheater 105. Moisture separator 105 removes most of the entrained water droplets, draining them in line 107 to deaerator 106 (via a link not shown in FIG. 1), and the steam flow remaining in moisture separator/reheater 105 is reheated. The steam flow through reheater 105 is heated by saturated steam in line 108 from steam generator 100 and/or with bled steam (not shown) from high pressure turbine 103. The heating steam is condensed in the reheater and the condensed water is returned to the condensate of system high pressure feedheaters 109 via a link not shown in FIG. 1.

The steam entering the reheater flows in turn over heat transfer surfaces with their outlet passes at the side receiving the highest temperature fluid from the heat exchanger to maintain a near constant temperature difference between the external steam and internal process fluid.

Reheated steam from moisture separator/reheater 105 is recovered in line 110 and expanded through low pressure steam turbine 111. The steam from turbine 111 passes in line 112 to condenser 113 and the condensed water is recovered in line 114 and pumped by pump 115 through one or more low pressure feedheaters 117 to deaerator 106. Steam extracted from between stages of the steam turbine is used to supply heat to the feedheaters. The water condensed in the feedheaters is cascaded (not shown) to a feedheater at lower temperature or discharged into condenser 113.

Dissolved gases are removed by vigorous direct contact heating of water droplets by steam in the deaerator 106. The heating steam for deaerator 106 is taken either from the exhaust or from between stages of high pressure steam turbine 103. The water from deaerator 106 is pumped to high pressure by one or more feed pumps 121 and further heated by one or more high pressure feedheaters 109 to a temperature suitable for return to the steam generator 100 in line 124.

The high pressure feedheaters are heated with steam extracted from between stages of the steam turbine 103 and with hot water from the condensed heating steam flows to reheater 105. The steam condensed in the feedheaters and the water flows are cascaded (not shown) to a feedheater at lower pressure and/or to the deaerator 106.

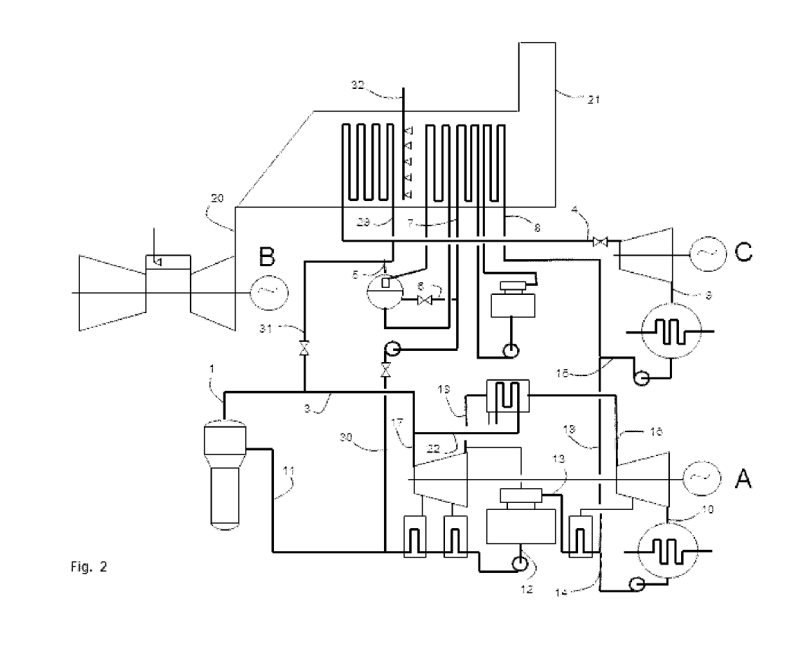

FIG. 2 shows a hybrid power generation plant arranged to operate in the same way as described above in connection with FIG. 1. The reference numerals in FIG. 2 correspond to the points at which the data outlined in Table 1 below are obtained.

TABLE 1

| | | Reference | | | With additional | | |
|---|---|---|---|---|---|---|---|
| | | Condition | | | heat input | | |
| | Ref. | kg/s | bara | C. | kg/s | bara | C. |
| Steam generator output | 1 | 1503 | 66.3 | 282 | 1518 | 66.8 | 283 |
| Net main steam flow | 3 | 1291 | 66.1 | 280 | 1501 | 66.8 | 283 |
| NuGas ST steam | 4 | 224 | 60.5 | 566 | 224 | 60.5 | 566 |
| HRSG evaporator outlet | 5 | 12 | 65.1 | 281 | 206 | 65.1 | 281 |
| Evaporator feed | 6 | 12 | 65.1 | 278 | 206 | 65.1 | 256 |
| Economiser outlet | 7 | 112 | 65.1 | 278 | 214 | 65.1 | 256 |
| Economiser inlet | 8 | 103 | 3.5 | 30 | 184 | 2.9 | 29 |
| NuGas ST exhaust | 9 | 222 | 0.04 | 30 | 202 | 0.04 | 29 |
| Nuclear ST exhaust | 10 | 627 | 0.04 | 27 | 758 | 0.04 | 30 |
| Steam generator feedwater | 11 | 1503 | 73 | 222 | 1519 | 73 | 226 |
| Nuclear DA outlet | 12 | 1437 | 4.7 | 152 | 1546 | 5.6 | 158 |
| Nuclear DA inlet condensate | 13 | 934 | 7.0 | 121 | 978 | 7.9 | 127 |
| Nuclear ST condensate | 14 | 864 | 14 | 27 | 903 | 15 | 30 |
| NuGas ST condensate | 15 | 222 | 3.6 | 30 | 202 | 2.9 | 29 |
| Nuclear ST MSR Outlet | 16 | 787 | 4.7 | 274 | 933 | 5.5 | 272 |
| Nuclear ST HP inlet | 17 | 1222 | 64.2 | 280 | 1429 | 64.2 | 280 |
| MSR inlet | 18 | 911 | 4.9 | 151 | 1077 | 5.8 | 157 |
| NuGas condensate to Nuclear | 19 | 120 | 14 | 30 | 18 | 15 | 30 |
| GT exhaust | 20 | 537 | 1.04 | 610 | 537 | 1.04 | 610 |
| HRSG stack | 21 | 537 | 1.02 | 88 | 549 | 1.02 | 88 |
| MSR heating steam | 22 | 69 | 64.2 | 280 | 72 | 64.2 | 280 |
| HRSG superheater inlet | 29 | 224 | 65.1 | 281 | 224 | 65.1 | 281 |
| Nuclear to NuGas transfer steam | 31 | 212 | 65.5 | 281 | 18 | 66.8 | 283 |
| HRSG firing gas | 32 | 0 | — | — | 7.2 | 2 | 25 |
| Generator Outputs (MW) | A | 808 | | | 932 | | |
| | B | 227 | | | 227 | | |
| | C | 291.5 | | | 283 | | |

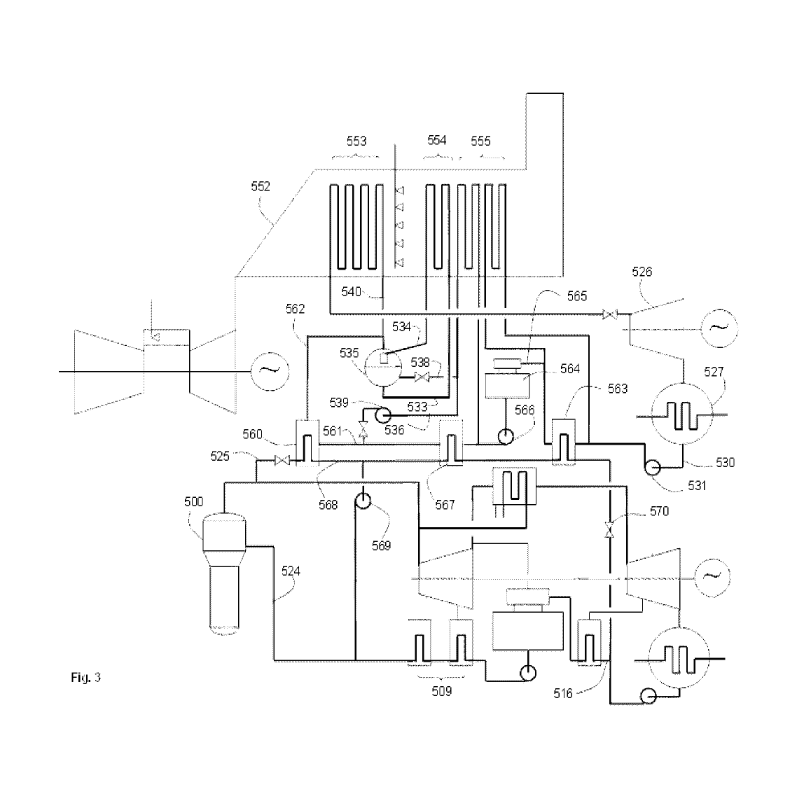

Referring to FIG. 3, the cycle applied to the plant follows the process and references as described for FIG. 1 except as follows:

The second stream from steam generator 500 is carried by line 525 to steam heated evaporator 560. Secondary steam is generated by evaporating the feedwater delivered in line 561 by condensing the incoming flow from line 525. The secondary steam is supplied by line 562 to the superheater 553 for heating and is delivered at high temperature to steam turbine 526 which exhausts into condenser 527. Condensed water is recovered via line 530 and delivered by pump 531 as a stream which is divided into two parallel streams for heating and delivery to second deaerator 564. The first stream is delivered to feedheater 563 while the second part is delivered to the first section of economizer 555 in energy recovery heat exchanger 552. The heated recovered streams from the feedheater and economizer are mixed and delivered to the second deaerator 564 in line 565.

The second deaerator 564 removes dissolved gases from the condensed water using vigorous direct contact heating with steam supplied to the deaerator from the separator 535 or steam turbine extraction (connections not shown for clarity). The resulting hot water, pumped to high pressure by the one or more feed pumps 566, is divided into two streams. The first stream is delivered to the second section of economizer 555 of the gas turbine energy recovery heat exchanger 552. The heated recovered stream is further split into a stream to separator 535 via line 538 and a stream in line 536 to optional pump 539 for delivery as feedwater into line 561. The second stream delivered by the one or more feed pumps 566 is heated in the water to water feedheater 567 and recovered into line 561. The mixed heated water flow in line 561 is delivered to the steam heated evaporator 560 to generate secondary steam.

Feedwater supplied to separator 535 is circulated by convection or by pump(s) (not shown) through evaporator section 554 of the energy recovery heat exchanger 552 via lines 533 and 534. The steam stream from separator 535 is mixed with secondary steam from steam heated evaporator 560 in line 540.

The steam flow from line 525 condensed in the steam heated evaporator is recovered via line 568 and divided into two parts. The first part is delivered by pump 569 to mix in line 524 with the heated feedwater from feedheaters 509 to be supplied to the steam generator 500. The second part is delivered to water to water feedheater 567 where it heats part of the stream from the one or more feed pumps 566. The recovered cooled part is delivered to feedheater 563 where it heats part of the condensate pumped from the condenser 527. The cooled condensed stream is reduced in pressure in valve 570 and returned to the main cycle in line 516.

What is claimed is:

1. A process for power generation comprising:
providing a steam generator, a first steam turbine, a second steam turbine, a third steam turbine, a reheater, a gas turbine, at least one heat exchanger, and a combustion means for burning fuel in hot gas;
the process having plural modes of operation comprising:
a first mode of operation comprising:
supplying a first stream of feedwater to the steam generator and generating a steam output therefrom;
supplying a first stream comprising steam from the steam generator to the first steam turbine to generate power in the first steam turbine;
recovering from the first steam turbine a recovered stream comprising steam and supplying at least a part of the recovered stream to the reheater;
supplying a second stream comprising steam from the steam generator to the heat exchanger and heating the second stream therein by supplying at least one hot exhaust gas stream from the gas turbine to the heat exchanger;
supplying the heated second stream to the second steam turbine to generate power therein;
supplying a third stream comprising steam from the steam generator to the reheater to heat the recovered stream from the first steam turbine;
recovering from the reheater a heated recovered stream from the first turbine; and
supplying at least part of the heated recovered stream from the first turbine to the third steam turbine to generate power therein;
a second mode of operation of the plant comprising:
supplying the first stream of feedwater to the steam generator and generating a stream of steam therefrom;
supplying the first stream comprising steam from the steam generator to the first steam turbine to generate power in the first steam turbine;
recovering from the first steam turbine the recovered stream comprising steam and supplying at least part of the recovered stream to the reheater;
supplying the second stream comprising steam from the steam generator to the reheater to heat the recovered steam from the first steam turbine;
recovering from the reheater the heated recovered stream from the first steam turbine; and
supplying at least part of the heated recovered stream from the first steam turbine to the third steam turbine to generate power in the third steam turbine;
a third mode of operation of the plant comprising:
supplying feedwater bypassing the steam generator to the heat exchanger and heating the feedwater stream therein by supplying the at least one hot exhaust gas stream from the gas turbine to the heat exchanger; and
recovering heated steam from the heat exchanger and supplying at least part of the recovered heated steam stream to the second steam turbine to generate power in the second steam turbine; and
a fourth mode of operation of the plant comprising at least one of the first or third mode of operation, further comprising:
recovering an exhaust gas stream from the heat exchanger; and
combusting an additional fuel to reheat the exhaust gas stream before the exhaust gas stream is supplied back to the heat exchanger.

2. A process according to claim 1 wherein the heat exchanger has plural zones, including at least a first zone and a second zone.

3. A process according to claim 2 wherein the first zone and the second zone of the heat exchanger are separate from each other.

4. A process according to claim 2 wherein at least one exhaust gas stream is recovered from the first zone of the heat exchanger and is supplied to the second zone of the heat exchanger.

5. A process according to claim 4 wherein the additional fuel is combusted to reheat the exhaust gas stream before the exhaust gas stream is supplied to the second zone of the heat exchanger.

6. A process according to claim 4 wherein the first mode comprises supplying the second stream comprising steam from the steam generator to the first zone of the heat exchanger, wherein the second stream is heated therein by supplying the at least one hot exhaust gas stream from the gas turbine to the first zone of the heat exchanger.

7. A process according to claim 6 wherein the first mode further comprises the steps of:
supplying the second stream of feedwater to the second zone of the heat exchanger;
generating a stream comprising steam in the second zone of the heat exchanger; and
mixing the steam from the second zone of the heat exchanger with the second stream of steam from the steam generator.

8. A process according to claim 7 wherein the stream comprising steam created in the second zone of the heat exchanger is supplied to a separator before the steam in the stream is mixed with the second stream of steam from the steam generator and water produced in the separator is supplied to the steam generator as at least part of the feedwater supplied thereto.

9. A process according to claim 2 wherein in the third mode of operation of the plant, the feedwater bypassing the steam generator is supplied to the second zone of the heat exchanger in which the feedwater is heated and at least partially evaporated before the feedwater is supplied to the first zone of the heat exchanger.

10. A process according to claim 9 wherein the stream supplied to the first zone of the heat exchanger is heated therein by supplying the at least one hot exhaust gas stream from the gas turbine to the first zone of the heat exchanger.

11. A process according to claim 9 wherein the third mode of operation comprises:
supplying the at least partially evaporated heated feedwater stream from the second zone of the heat exchanger to a separator; and
recovering from the separator a steam stream and supplying said steam stream to the first zone of the heat exchanger.

12. A process according to claim 2 wherein in said first mode of operation of the plant the second stream from the steam generator is supplied to the first zone of the heat exchanger at a temperature and pressure not substantially below that of the second stream as the second stream is recovered from the steam generator.

13. A process according to claim 1 wherein an output stream from the second and/or third steam turbine is supplied, in whole or in part to one or more condensers.

14. A process according to claim 13 wherein at least part of the output stream(s) from the condenser(s) is supplied to a third zone of the heat exchanger and heated therein by supplying the at least one hot exhaust gas stream from the gas turbine to the third zone of the heat exchanger.

15. A process according to claim 14 wherein the part of the output stream(s) from the condenser(s) supplied to the third zone of the heat exchanger is passed through one or more low pressure feedheaters.

16. A process according to claim 14 wherein the at least one hot exhaust gas stream from the gas turbine is passed sequentially against at least one first heat transfer surface, at least one second heat transfer surface and at least one third heat transfer surface, becoming progressively cooler from the first to the third zones of the heat exchanger.

17. A process according to claim 1 wherein in said first or second modes of operation of the plant, the first steam turbine is a wet steam turbine and the steam in the first stream from the steam generator is supplied at or at close to a saturated condition.

18. A process according to claim 1 wherein a flow ratio of the stream supplied to the second steam turbine to the first steam stream from the steam generator is between about 0.05 to about 0.5.

19. A process according to claim 1 wherein in the first mode of operation at least part of the feedwater is supplied to the steam generator via a high temperature feedheater.

20. A process according to claim 1 wherein an energy flow of the at least one hot exhaust gas stream supplied from the gas turbine is from about 0.05 to about 0.3 of a net enthalpy of materials recovered from the steam generator.

21. A process according to claim 1 in which a ratio of maximum energy added in additional fuel to energy in exhaust gases of the gas turbine is between 50 to 120%, preferably between 60 and 110% and more preferably between 80 and 100%.

22. A process according to claim 1, wherein the feedwater used to provide steam to the second steam turbine is isolated from the feedwater used to provide steam to the first and/or third steam turbines.

23. A process according to claim 22 wherein the first mode of operation further includes passing the second stream comprising steam from the steam generator to a steam heated evaporator in which a flow of feedwater that is isolated from the second stream comprising steam from the steam generator is evaporated by at least partially condensing the second stream comprising steam from the steam generator and is subsequently passed to the heat exchanger and then to the second steam turbine.

24. A process according to claim 23 wherein the first mode of operation further includes passing the condensed water recovered from the second steam turbine through one or more feedheaters in which the condensed water is heated by cooling or at least partially condensing the second stream comprising steam from the steam generator.

25. A power generation plant configured to operate the process for power generation comprising:
providing a steam generator, a first steam turbine, a second steam turbine and a third steam turbine, a reheater, a gas turbine, at least one heat exchanger and a combustion means for burning fuel in hot gas;
wherein the power plant is configured for a first mode of operation comprising:
supplying a first stream of feedwater to the steam generator and generating a steam output therefrom;
supplying a first stream comprising steam from the steam generator to the first steam turbine to generate power in the first steam turbine;
recovering from the first steam turbine a recovered stream comprising steam and supplying at least a part of the recovered stream to the reheater;
supplying a second stream comprising steam from the steam generator to the heat exchanger and heating the second stream therein by supplying at least one hot exhaust gas stream from the gas turbine to the heat exchanger;
supplying the heated second stream to the second steam turbine to generate power therein;
supplying a third stream comprising steam from the steam generator to the reheater to heat the recovered stream from the first steam turbine;
recovering from the reheater a heated recovered stream from the first turbine; and
supplying at least part of the heated recovered stream from the first turbine to the third steam turbine to generate power therein;
wherein the power plant is configured for a second mode of operation comprising:
supplying the first stream of feedwater to the steam generator and generating a stream of steam therefrom;
supplying the first stream comprising steam from the steam generator to the first steam turbine to generate power in the first steam turbine;
recovering from the first steam turbine the recovered stream comprising steam and supplying at least part of the recovered stream to the reheater;
supplying the second stream comprising steam from the steam generator to the reheater to heat the recovered steam from the first steam turbine;
recovering from the reheater the heated recovered stream from the first steam turbine; and
supplying at least part of the heated recovered stream from the first steam turbine to the third steam turbine to generate power in the third steam turbine;
wherein the power plant is configured for a third mode of operation of the plant comprising:
supplying feedwater bypassing the steam generator to the heat exchanger and heating the feedwater stream therein by supplying the at least one hot exhaust gas stream from the gas turbine to the heat exchanger; and
recovering heated steam from the heat exchanger and supplying at least part of the recovered heated steam stream to the second steam turbine to generate power in the second steam turbine; and
wherein the power plant is configured for a fourth mode of operation of the plant comprising at least one of either the first or third mode of operation and further comprising:
recovering an exhaust gas stream from the heat exchanger; and
combusting an additional fuel to reheat the exhaust gas stream before the exhaust gas stream is supplied back to the heat exchanger.
